(19) United States
(12) Patent Application Publication
(10) Pub. No.: US 2013/0232027 A1
(43) Pub. Date: Sep. 5, 2013

(54) Fleet Purchase Planner

(71) Applicant: FORD GLOBAL TECHNOLOGIES, LLC, Dearborn, MI (US)

(72) Inventors: Daniel Reich, Royal Oak, MI (US); Sandra L. Winkler, Allen Park, MI (US); Erica Z. Klampfl, Canton, MI (US); Natalie I. Olson, Novi, MI (US); John Matthew Ginder, Plymouth, MI (US); Timothy John Wallington, Ann Arbor, MI (US)

(73) Assignee: Ford Global Technologies, LLC, Dearborn, MI (US)

(21) Appl. No.: 13/780,844

(22) Filed: Feb. 28, 2013

Related U.S. Application Data
(60) Provisional application No. 61/676,885, filed on Jul. 27, 2012.
(60) Provisional application No. 61/605,745, filed on Mar. 1, 2012.

(51) Int. Cl. G06Q 30/06

(52) U.S. Cl. CPC G06Q 30/0631
USPC 705/26.7

(57) ABSTRACT

A system and method for generating a vehicle fleet configuration for purchase, replacement, and/or deployment of vehicles include an input device configured to receive user input indicative of a number of vehicles to purchase and at least one fleet operational parameter target. A computer in communication with the input device and a database having emissions and fuel economy information for a plurality of available vehicle models and associated powertrain configurations is configured to generate a recommended number of vehicles for each of the available vehicle models with associated powertrain configurations to satisfy the number of vehicles to purchase, wherein the operational parameters associated with the number of vehicles satisfy at least one fleet operational parameter target, which may include one of minimizing cost or minimizing emissions, for example.

### CROSS-REFERENCE TO RELATED APPLICATION

This application claims the benefit under 35 U.S.C. §119(e) of U.S. provisional application Ser. No. 61/605,745 filed on Mar. 1, 2012 and U.S. provisional application Ser. No. 61/676,885 filed on Jul. 27, 2012, the disclosures of which are hereby incorporated by reference in their entirety.

### TECHNICAL FIELD

The present disclosure relates to a system and method for vehicle fleet purchase recommendations based on one or more designated customer parameters.

### BACKGROUND

Vehicle fleet purchases may represent significant sales to automotive manufacturers, and may also represent significant costs to business owners that use vehicle fleets to meet their business needs and goals. Fleet customers may purchase hundreds or thousands of vehicles at once that are replaced between every few months and every few years. Ensuring that fleet customers receive products that are within budget, that meet driving needs, and contribute to corporate targets is important to both the vehicle manufacturer and the customer. While customers have traditionally been concerned about the total cost of ownership of the vehicles they purchase, sustainability and environmental impact are areas of growing importance to many fleet customers.

In recent years, many new propulsion technologies have emerged including advanced combustion and emission control technologies for conventional carbon-based fuels and alternative fuels in addition to more recent green vehicle technologies (e.g. electric vehicles (EVs), hybrid EV (HEVs), plug in HEVs (PHEVs), battery electric vehicles (BEVs), fuel cell vehicles, turbocharged direct-injected (TDI or EcoBoost®)). The availability of vehicles incorporating advanced/green propulsion technologies presents organizations with an opportunity to reduce emissions and lower fuel costs by increasing the fuel economy of their fleets. However, it also presents customers with many options for vehicle models and powertrain configurations without much insight into the best overall fleet configuration and deployment to various geographic regions to meet various needs, such as fuel economy, reduction in emissions, use of alternative fuels, and overall cost as alternative fuel and green technology options may come with a higher acquisition cost, but lower operating or overall cost of ownership. For example, fleet customers may want to know the trade-offs for purchasing a conventional fuel model relative to a BEV model, including the return on investment, time required to recover the acquisition cost differential, impact on overall fleet emissions, whether a BEV has the same associated emissions if operated (and recharged) in California as it does in Michigan, etc.

Purchase decisions become even more complex as fleet owners contemplate which vehicles in an existing fleet to replace, which vehicles and configurations should be used to replace them, how the available options may impact cost and sustainability targets, and where to deploy particular vehicles to achieve desired cost and/or sustainability goals. The number of combinations and permutations of vehicles, configurations, and customer goals has made a traditionally significant task even more of a complex and complicated undertaking.

Generating fleet purchase recommendations is currently an essentially manual process that depends on the experience, expertise, and data available to the customer and fleet sales professional. Various publicly available or proprietary software tools have been developed to assist various fleet management and configuration functions, such as comparing emissions, estimating fuel costs, maintenance costs, lifecycle costs, and resale or residual values, for example. However, these tools do not generate purchase recommendations, replacement recommendations, and/or deployment recommendations to achieve customer sustainability targets, corporate financial targets, and/or vehicle preferences to provide customers with an integrated fleet purchase planning tool.

### SUMMARY

In one embodiment, a system for generating purchase, replacement, and/or deployment recommendations for a fleet of vehicles includes an input device configured to receive user input indicative of a number of vehicles to purchase and at least one fleet operational parameter target and a computer in communication with the input device and a database having fuel economy information for a plurality of available vehicle models and associated powertrain configurations, the computer configured to generate a recommended number of vehicles for each of the available vehicle models with associated powertrain configurations to satisfy the number of vehicles to purchase, wherein the operational parameters associated with the number of vehicles satisfy at least one fleet operational parameter target. In one embodiment, the fleet operational parameter target includes at least one of minimizing fleet purchase cost and minimizing fleet emissions. Various embodiments may include an optimization component implemented using a mathematical modeling framework to generate the fleet purchase recommendations that satisfy fleet customer constraints, which may include the total number of vehicles to purchase/analyze or the number of each of a plurality of available vehicle models or model/powertrain configurations. In one embodiment, the optimization component implements the mathematical modeling framework using the simplex method as coded in a JAVA® program executed by an associated microprocessor.

In one embodiment, the input device is a microprocessor-based input device, such as a tablet computer, that includes a user interface and communicates data via a wired or wireless network to the computer implementing the analytical engine. In various embodiments, the analytical engine and user interface are implemented by a single computer system that may have locally stored or remotely accessible database information including vehicle fuel economy data, financial data, safety data, and fuel/electricity pricing data by geographic region. The user interface receives information identifying which vehicles to compare, estimated annual mileage, percentage of city/highway driving, and expected fuel price. Information relative to a customer's current fleet may also be provided. Information may be manually entered, or transferred electronically in a specified format. In one embodiment, information relative to a customer fleet includes a vehicle identification number (VIN) for at least one vehicle in the customer fleet. The VIN number for each vehicle is decoded to determine an associated vehicle powertrain configuration and related data, such as fuel economy, emissions, electricity (power) usage, etc. The information entered using the user interface and/or obtained using the VIN is used by the analytical engine, which accesses one or more local or remote databases to obtain fuel economy data, financial data, and fuel pricing data for one or more geographic regions. The analytical engine performs an optimization to generate recommendations, which may include purchase recommendations, replacement recommendations, and deployment recommendations for particular geographic regions to meet the customer objectives. In one embodiment, the objective is to minimize the purchase cost while providing a desired mix of vehicle models that meet a sustainability or emissions goal. In one embodiment, the analytical engine iteratively determines cost/emissions pairs to generate a Pareto frontier that may be used in the purchase, replacement, and/or deployment recommendations.

Embodiments according to the present disclosure may include a method for automatically generating a vehicle fleet purchase recommendation including receiving input indicative of a total number of fleet vehicles and at least one goal or objective of minimizing fleet emissions or minimizing fleet purchase cost. The method may include using a computer to retrieve vehicle configuration information associated with a vehicle identification number (VIN) for each existing fleet vehicle and related emissions data associated with each of a plurality of available vehicle models and powertrain configurations from one or more local and/or network accessible databases, and determine a corresponding number for each of a plurality of vehicle models and powertrain configurations to satisfy the input using an optimization model constrained by the total number of fleet vehicles. The method may also include storing recommended fleet configurations in a customer database and communicating the recommended fleet configurations to a customer over a wired or wireless computer network. The recommend fleet configuration may include a number and associated type of vehicle to replace, one or more geographic regions to deploy particular vehicles, and/or vehicles to purchase for replacement or to expand a vehicle fleet.

Various embodiments according to the present disclosure provide associated advantages. For example, embodiments according to the present disclosure provide an integrated and comprehensive fleet purchase planner for quickly, efficiently, and automatically generating fleet purchase recommendations to satisfy customer goals and requirements, such as those associated with a fleet emissions footprint and/or cost of ownership, for example. Various embodiments provide an interactive software tool and associated user interface that can be used by fleet account managers to automatically develop tailored purchase recommendations for fleet customers. The recommendations help customers achieve their sustainability and financial targets, while taking into account various vehicle metrics, such as safety ratings, fuel economy, carbon footprint, and other vehicle preferences, when planning fleet purchases.

Embodiments of the present disclosure include a software system designed to identify the most cost effective opportunities for vehicle fleets to improve their sustainability through new purchases, replacement of existing fleet vehicles, and/or strategic deployment or redeployment of existing or new vehicles to designated geographic regions. Various embodiments of the fleet purchase planner of the present disclosure leverage several local and/or network accessible data sources, including vehicle fuel economy, segmentation, current fleet composition, and driving patterns. Embodiments may include integer programming models that generate a Pareto frontier to illustrate the relationship between two or more customer designated fleet parameters, such as cost and sustainability, for example.

The above advantages and other advantages and features will be readily apparent from the following detailed description of the preferred embodiments when taken in connection with the accompanying drawings.

### BRIEF DESCRIPTION OF THE DRAWINGS

FIG. 1 is a block diagram illustrating operation of a representative embodiment of a system or method for a fleet configuration planner to achieve a desired customer goal according to the present disclosure;

FIG. 2 illustrates representative geographic regions that may be used to calculate electricity emission factors for use in a fleet configuration planner in various embodiments of the present disclosure;

FIG. 3 illustrates a representative user interface data entry template according to one embodiment of a fleet configuration planning tool according to the present disclosure;

FIG. 4 illustrates a representative vehicle segmentation or type table used for entering or storing cross-reference information to replace existing fleet vehicles with vehicles from a designated vehicle market segment or type according to various embodiments of the present disclosure;

FIG. 5 illustrates a representative user interface data entry template or screen for specifying powertrain types for vehicles to be configured according to various embodiments of the present disclosure;

FIG. 6 is a flowchart illustrating operation of one embodiment of a system or method for generating vehicle fleet configuration recommendations according to the present disclosure;

FIG. 7 is a graph illustrating representative fleet configurations to meet one or more customer goals or objectives as determined by a representative embodiment of the present disclosure;

FIG. 8 is a representative summary report for fleet configuration recommendations generated by a representative embodiment of a system or method according to the present disclosure;

FIG. 9 is a representative detailed report for multiple vehicle fleet configuration options corresponding to points on the Pareto frontier generated by a representative embodiment according to the present disclosure; and

FIG. 10 illustrates the effect of strategic geographic deployment of various hybrid powertrain vehicles for a vehicle fleet configuration according to various embodiments of the present disclosure.

### DETAILED DESCRIPTION

Detailed representative embodiments according to the present disclosure are described and illustrated with reference to the drawings. It is to be understood that the selected embodiments are merely exemplary and that the disclosure contemplates various and alternative forms. The figures are not necessarily to scale; some features may be exaggerated or minimized to show details of particular components. Specific structural and functional details disclosed herein are therefore not to be interpreted as limiting, but merely as a representative basis for teaching one skilled in the art to variously employ the embodiments.

As those of ordinary skill in the art will understand, various features of the embodiments illustrated and described with reference to any one of the Figures may be combined with features illustrated in one or more other Figures to produce embodiments having combinations of components or features that are not explicitly illustrated or described. The combinations of features illustrated provide representative embodiments for typical applications. However, various combinations and modifications of the features consistent with the teachings of the present disclosure may be desired for particular applications or implementations. The representative embodiments used in the illustrations relate generally to systems or methods for automatically generating vehicle fleet purchase recommendations for a customer or user based on one or more specified customer goals, constraints, or criteria. However, the teachings of the present disclosure may also be used in other applications. Those of ordinary skill in the art may recognize similar applications or implementations consistent with the teachings of the present disclosure.

Various Figures include block diagrams and/or flow charts to illustrate operation of a system or method for vehicle fleet configuration recommendations for purchase, replacement and/or deployment recommendations according to embodiments of the present disclosure. Such illustrations generally represent control logic and/or program code that may be performed by software and/or hardware to accomplish the functions illustrated and may include various ancillary functions well known by those of ordinary skill in the art. While specific representative implementations may be described for one or more embodiments, this disclosure is independent of the particular hardware or software described.

The diagrams of various figures may represent any of a number of known processing strategies such as event-driven, interrupt-driven, multi-tasking, multi-threading, and the like performed by one or more processors deployed in integrated or discrete hardware. As such, various functions illustrated may be performed by one or more processors in the sequence illustrated, in parallel, or in some cases omitted. Likewise, the order of processing is not necessarily required to achieve the features and advantages of the disclosure, but is provided for ease of illustration and description. The control logic may be embodied in a computer readable medium, such as a hard disk, CD ROM, PROM, EPROM, etc. and may be implemented by program code or software executed by one or more microprocessors or computers that may communicate over a wired or wireless local or wide area network, such as the internet. Of course, various aspects of the control logic may also be implemented by dedicated hardware that may include embedded special-purpose processors consistent with the teachings of the present disclosure.

As consumers become increasingly aware of the contribution of vehicle greenhouse gas (GHG) emissions toward climate change, they seek opportunities to reduce their global warming footprint. Carbon dioxide (CO₂) is the primary GHG and is the main emission from motor vehicles. CO₂ and water (H₂O) are the end products of combustion, a chemical reaction of hydrocarbon (HC) fuels such as gasoline, diesel, natural gas, and coal with oxygen (O₂). The chemical reaction may be represented by: HC+O₂→H₂O+CO₂+energy. Consumers can reduce vehicle CO₂ emissions by using less fuel. This can be accomplished by selecting vehicles that have better fuel efficiency, using less carbon-intensive fuels, or by driving fewer miles, for example.

As described in greater detail below, various embodiments of a fleet configuration planner according to the present disclosure use a well-to-wheels (WTW) approach to quantify the CO₂ emissions from a vehicle fleet. WTW CO₂ includes both the direct emissions from the combustion of fossil fuel by the vehicle, also known as tailpipe emissions or tank-to-wheel (TTW) emissions, as well as the upstream, or well-to-tank (WTT), emissions. WTT emissions are introduced when the feedstock for the finished fuel is extracted or grown, transported, and refined into a usable fuel or used to generate electricity. For representative vehicles, the WTW emissions may represent up to 80% of the vehicle life cycle CO₂, while raw materials, manufacturing and assembly, maintenance, and end of life account for the remainder of vehicle life cycle CO₂ emissions. Conventional internal combustion engine vehicles (ICEVs) have about 80% of the life cycle CO₂ in the WTW phase. With advanced technologies such as HEVs becoming more prevalent, vehicle fuel efficiency improves, reducing the WTW CO₂. However, the manufacturing or raw materials become more carbon intense; for example, the WTW share of life cycle CO₂ for BEVs can decrease to around 50-60% for representative vehicles.

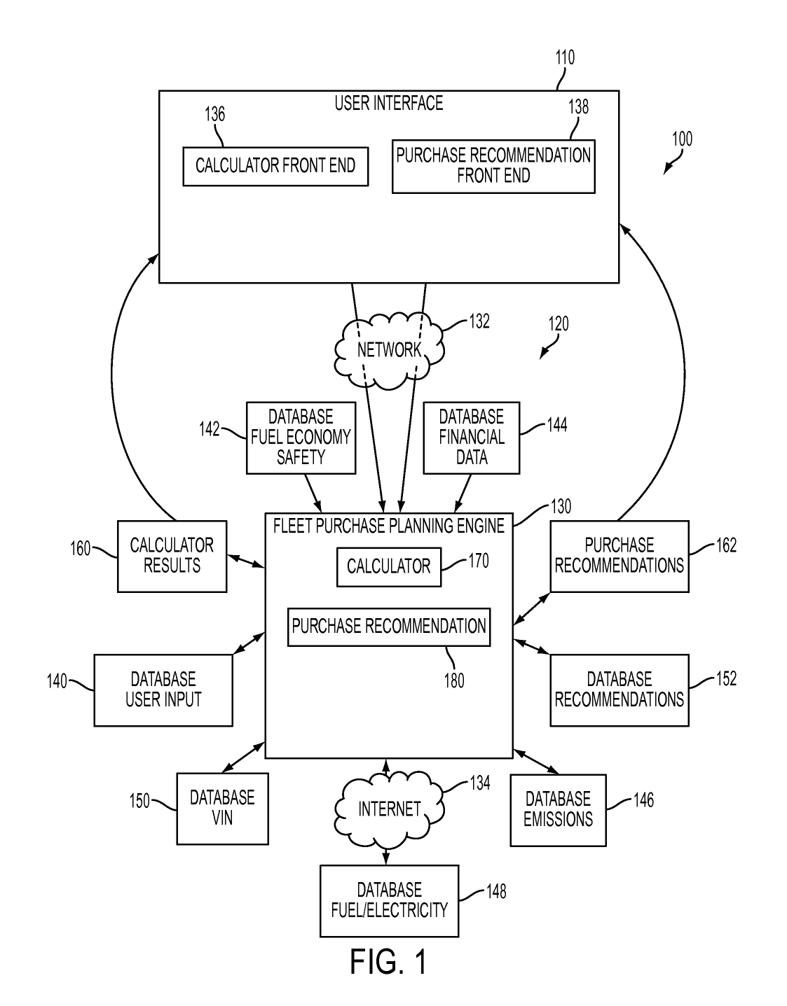

As generally illustrated in the block diagram of FIG. 1, a system and method for vehicle fleet configuration recommendations of one representative embodiment according to the present disclosure is implemented by an integrated and comprehensive system that automatically provides recommendations to meet one or more customer goals. The system and methods of the present disclosure address the complexity of vehicle model selection and powertrain configuration by providing a microprocessor-based input device with a user interface to capture customer goals and optional data related to current fleet vehicles to allow fleet account managers to quickly access automatically generated fleet configuration recommendations and provide customers with various information, which may include, but is not limited to a vehicle fleet emissions footprint and financial statistics associated with one or more model fleet configuration recommendations. Systems and methods illustrated by various embodiments of the present disclosure can be used by fleet sales managers and/or customers to develop tailored fleet configuration recommendations including purchase, replacement, and/or deployment recommendations for fleet customers. The recommendations help customers achieve various goals, such as environmental sustainability and financial targets, while taking into account safety ratings and other vehicle preferences, when planning fleet configurations. While the representative embodiments are described with respect to customer goals or objectives related to cost and emissions, various embodiments may provide recommendations based on different customer goals or objectives and/or dealer goals or objectives.

The simplified block diagram illustrated in FIG. 1 provides an overview of a vehicle fleet purchase planning (FPP) tool 100 of a representative embodiment according to the present disclosure. In the representative embodiment of FIG. 1, the system 100 includes a user interface 110, one or more databases 120 stored in corresponding computer readable storage media, and a computer-implemented fleet purchase/configuration planning (FPP) engine 130.

The FPP user interface may be implemented in any number of ways using one or more programmed microprocessor-based input devices. For example, user interface 110 can be implemented by a desktop application and associated computer, a mobile application running on a handheld mobile device such as a smart-phone or tablet, and/or as a web-based application. If implemented by a web-based application, the system may be accessed using a thin client or web browser running on a desktop or mobile device over a wired or wireless communication network/link generally represented by network 132 and internet 134 as generally understood by those of ordinary skill in the art. Regardless of the platform and type of input/output device, user interface 110 may be used by a fleet account manager to create a user account for fleet configuration planning and individual fleet customer profiles within that account.

In the representative embodiment illustrated, user interface 110 provides front ends for two main functions or components 136, 138 of the system and method for vehicle fleet configuration/purchase recommendations. The present disclosure is generally independent of the particular type of input device and the specific user interface that may be used to capture user input and display recommended fleet configurations. In various embodiments, user data may be manually entered via associated interactive display screens using prompts, menus, toolbars, etc. of user interface 110. In other embodiments, some or all customer data may be electronically transferred in a formatted file, such as a comma or other character delimited format, for example. Those of ordinary skill in the art will recognize that user input may be entered using a physical keyboard, voice recognition, touch screen, or any combination thereof and displayed or presented to the user in a similar fashion.

In the embodiment of FIG. 1, a first front end 136 may include an entry screen or form used to capture and display information for a vehicle fleet emissions and fuel cost calculator. The user may select vehicles for which an emission and fuel cost comparison is desired, which may be useful in quickly responding to customer questions, in planning requirements for orders, and in further customizing fleet configuration recommendations automatically generated by the FPP engine. Other information may include annual mileage, percentage of city vs. highway driving, and an expected fuel price. In one embodiment, customer information may include one or more vehicle identification numbers (VINs). User information may be stored in an associated user input database 140 for subsequent access. User or customer information or data may be used to query or access one or more publicly available or proprietary databases 120, which may be locally or remotely accessible. Databases 120 may include a fuel economy and/or safety rating database 142, a financial database 144, an emissions database 146, a regional fuel/electricity cost database 148 and a VIN database 150, for example. Vehicle fleet configuration recommendations may be stored along with customer information in an associated database 152, with various results 160 and recommendations 162 presented to the user via user interface 110 as described in greater detail below.

A second front end 138 may include a data entry/capture screen or device of user interface 110 that may be used to capture at least one vehicle fleet customer parameter, which may include a performance goal or requirement, a number of vehicles, a maximum cost, etc. as illustrated and described in greater detail herein. Account managers can enter information about customers and new purchase order specifications or regional vehicle deployment goals, for example. Existing customer fleet information may include vehicle make, model, configuration, mileage, vehicles to remove or redeploy, vehicle models of interest. Information may be manually or electronically entered and/or obtained from one or more databases 120. For example, entry of a VIN may be used to query VIN database 150 to obtain vehicle make, model, and powertrain configuration, which may then be used to query fuel economy database 142, emissions database 146, and fuel/electricity cost database 148. In one embodiment, input includes but is not limited to, the total number of vehicles to be acquired in the fleet order. Optional inputs may include the miles per year per vehicle and/or the city/highway ratio or proportion of miles. Alternatively, default values may be used for miles per year per vehicle, and the city/highway driving proportion. Other optional inputs may include information on the customer's current fleet, such as one or more vehicle identification numbers (VINs) or make and model information, an emissions goal, a fuel type, and an expected fuel price, for example. Inputs may also include deployment information that indicates a particular geographic service area for one or more vehicles to be replaced and/or acquired.

Both front ends for the vehicle fleet emissions and fuel cost calculator component 136 and for the purchase recommendation component 138 may provide reports to a screen or other output device as represented by blocks 160, 162 that may include one or more recommended fleet configurations and associated cost and emissions data. Other optional data associated with the current fleet vehicles and/or recommended fleet vehicles, such as safety ratings that may be retrieved from a publicly available database 142 stored locally or accessible over a local or wide area computer network may also be provided. For example, safety ratings data may be obtained from government or commercial agencies such as NHTSA and IIHS and presented to users with associated fleet configurations depending on the particular implementation.

Various embodiments of a system or method for vehicle fleet purchase recommendations may utilize one or more databases 144 for storing financial data on available vehicles that are for sale/lease, as well as fuel economy and safety data 142 on all vehicles from all automakers for recent model years. In one embodiment, FPP 130 utilizes additional databases 140, 152 for storing user accounts and customer profiles and related information, to which inputs from the user interface 110 and purchase recommendations 162 provided by FPP 130 may be saved for future reference. One or more of the databases may be locally stored and/or accessible via a local or wide area network. In one embodiment, one or more databases are remotely located in a cloud implementation, on a server, or on an individual computer or mobile computing device depending on the required implementation.

Input data is sent by the user from the user interface 110 to the computer implementing the FPP engine 130, which then reads additional data from databases 120, which may include financial database 144 and fuel economy and safety database 142 as needed.

For the vehicle fleet emissions and fuel cost calculator component or function 170, FPP 130 computes the emissions footprint of the vehicles selected and their estimated annual fuel costs, using user inputs for mileage per year and expected fuel price. These calculations are described in greater detail below.

For the fleet configuration/purchase recommendation function 180, if the customer's current fleet is known, FPP 130 computes the fleet's baseline emissions footprint and estimated annual fuel cost. FPP 130 computes the emissions footprint of each vehicle for sale/acquisition and its estimated annual fuel cost, using user inputs for mileage per year per vehicle and expected fuel price. These calculations are extensions of those performed by the calculator function 170. FPP 130 then runs one or more integer programming optimization models, which are described in greater detail below. The optimization models produce one or more fleet configuration recommendations, which may include purchase, replacement, and/or deployment recommendations. The fleet configuration recommendations may be stored in one or more databases 140, 152 containing the user's account under the customer's profile and may also be sent back to user interface device 110 for display or other output through the user interface.

The representative embodiment of FPP system 100 described below may be implemented by a desktop computer or server using commercially available software with customization, such as Microsoft Excel, for both the user interface and the databases. In one embodiment, the FPP engine is coded in Java® and uses a commercially available software suite, such as CPLEX, for solving the integer programming optimization models. A version for multiple users could be developed with a mobile or web interface with the FPP engine 130 running on a server or through cloud computing.

In one embodiment, vehicle WTT and TTW CO₂ emissions are calculated by FPP engine 130 based on the vehicle fuel economy (miles per gallon, MPG) reported by a government agency, such as the U.S. EPA and DOE. Of course, fuel economy data and various other data and/or calculations used by the fleet configuration planner may be provided by one or more government or commercial databases, or may be adjusted by the customer or dealer if desired depending on the particular application and implementation. In one embodiment, vehicle configuration and fuel economy data is retrieved from corresponding databases 142, 146 over a wired or wireless network based on vehicle identification numbers 150 for existing customer fleet vehicles. In other embodiments, data may be entered via user interface 110 as previously described. Those of ordinary skill in the art will recognize that the representative calculations and assumptions described with respect to one or more representative embodiments may vary depending on the particular application and implementation, and that the representative embodiments described are generally independent of the particular source of data or calculations used.

Common liquid fuels may include gasoline and diesel, which may be blended with the biofuels ethanol and biodiesel, respectively. A mixture of 10% ethanol and 90% gasoline (by volume) is called E10, and is sold as gasoline across the U.S. E85 contains 85% ethanol by volume and is used only by flex-fuel vehicles (FFVs), which can operate on any blend from E0 (“pure” gasoline) to E85. Each fuel has associated TTW CO₂ emissions, which may be calculated from the physical and chemical properties of the fuel. In various embodiments of the present disclosure, the WTT CO₂ emissions for each fuel are obtained from a fuel life cycle assessment tool, such as the GREET 1.8d.0, developed at Argonne National Labs. Of course, embodiments of the present disclosure are generally independent of the source or manner of obtaining the various data or calculating the WTT and TTW emissions, fuel economy, vehicle cost, lifecycle cost, etc. used by the analytical engine to develop purchase, replacement, and/or deployment recommendations.

In addition to CO₂, other GHGs are emitted in smaller quantities, primarily during the WTT phase. However, the other GHGs, which include methane (CH₄) and nitrogen dioxide (N₂O) may have 25 times and 298 times, respectively, the global warming potential (GWP) of CO₂ over 100 years. As such, in some embodiments the emissions of CH₄ and N₂O may be weighted by their respective GWPs and combined with the CO₂ emissions to provide a single CO₂-equivalent GHG metric (CO₂ eq). Table 1 lists representative WTT and TTW CO₂ eq factors for representative fuels that may be used in various embodiments of a fleet purchase planner according to the present disclosure.

TABLE 1
WTT and TTW fuel emission factors.

GHG (kg CO₂eq/gal)

| | fWTT | fTTW |
|---|---|---|
| Gasoline | 2.2 | 8.9 |
| E10(corn ethanol) | 2.5 | 8.0 |
| E85(corn ethanol) | 4.7 | 1.3 |
| Diesel | 2.47 | 10.0 |
| B10(soy biodiesel) | 2.49 | 9.0 |

The factors in Table 1 include only fossil-based GHG emissions. Renewable biofuels, like neat ethanol E100, have no TTW fossil-based CO₂ emissions because there is no net increase in atmospheric CO₂ concentrations when the fuel is burned. The CO₂ is repeatedly emitted and reclaimed in a closed-cycle in which the ethanol is combusted, then absorbed from the atmosphere as the biomass (corn) grows. Fossil fuels like gasoline produce a net increase in atmospheric CO₂ by removing carbon stored underground and releasing it into the atmosphere with no mechanism for returning it underground. Biofuels have only WTT fossil-based CO₂ emissions.

For ICEVs, the annual metric tons of GHG emissions may be calculated as a function of fuel economy, distance traveled, and GHG emissions factors as represented in Table 1 according to equation (1) below. In various embodiments, HEVs are treated as ICEVs because the small on-board battery is recharged from the engine, not from an electric outlet. As such, the GHG emissions may be determined or calculated according to the following:

$${GHG}_{WTW} = VMT \frac{{f}_{WTT} + {f}_{TTW}}{1000 MPG} \qquad ( 1 )$$

where VMT is annual travel (miles); MPG is the fuel economy (miles/gallon), f_{WTT} is the well-to-tank (fuel production) emission factor (kg CO₂ eq/gallon), and f_{TTW} is the tank-to-wheel (fuel combustion) emission factor (kg CO₂ eq/gallon).

BEVs have only WTT CO₂ emissions. Like liquid fuels, electricity may come from both fossil and renewable sources. Renewable sources that have no WTT CO₂ may include hydropower, solar energy, biomass, and wind power, for example. Carbon intensities associated with fossil fuels combined with the efficiency of the power plant may be used to determine the electricity WTT CO₂ footprint. Representative WTT CO₂ factors for electricity that may be used in various embodiments of a fleet purchase planner according to the present disclosure are listed by feedstock fuel in Table 2 and include 8% transportation and distribution losses. As previously described, the actual values and/or methodology for assigning emissions to particular vehicle configurations may vary by application and implementation.

TABLE 2
WTT GHG emission factors for electricity generation, by fuel.

| | GHG (kg CO2eq/kWh) |
|---|---|
| | felec |
| Coal | 1.23 |
| Natural Gas | 0.64 |
| Oil | 1.03 |
| Nuclear | 0.02 |
| Renewables | 0.00 |

The emissions associated with the electricity used to charge the BEV battery generally varies across the country depending on the regional mix of fuels used in the power plants. Data may be obtained from various sources to determine or calculate an associated emissions value. For example, the GREET 1.8d.0 database provides regional fuel mixes for electric power plants in the Northeast and California. The mix for other regions may be obtained from various government or other publicly available sources. In one embodiment, data was extracted from the 2009 Annual Energy Outlook (AEO2009) supplemental tables, which use regions defined by the National Energy Modeling System (NEMS). The CO₂ factors from the GREET 1.8d.0 database and the AEO2009 regional electricity feedstock mix can be used to calculate the weighted average WTT CO₂ eq emission factors for a particular geographic region or state. Table 3 shows representative weighted emissions factors for various regions as illustrated in the geographic region map of FIG. 2. The size of a particular region and associated fuel mix for generation of electricity may vary depending on the particular application and implementation.

TABLE 3
Regional and state electricity GHG emission factors

| | Kg | | | | | |
|---|---|---|---|---|---|---|
| | CO₂eq per | | Natural | | | |
| Region # | kWh | Coal | Gas | Oil | Nuclear | Renewables |
| 1 | 1.074 | 84.2% | 4.7% | 0.3% | 10.0% | 0.8% |
| 2 | 0.734 | 36.3% | 44.1% | 0.1% | 12.5% | 7.0% |
| 3 + 6 + 7 | 0.412 | 29.9% | 21.7% | 2.2% | 33.9% | 12.3% |
| 4 | 0.728 | 56.2% | 4.2% | 0.2% | 35.2% | 4.2% |
| 5 | 0.893 | 71.5% | 0.8% | 0.3% | 14.1% | 13.3% |
| 8 | 0.763 | 34.1% | 42.3% | 6.6% | 14.1% | 2.9% |
| 9 | 0.743 | 52.3% | 13.6% | 0.5% | 29.4% | 4.2% |
| 10 | 0.990 | 69.0% | 21.0% | 0.3% | 4.4% | 5.3% |
| 11 | 0.440 | 31.6% | 7.6% | 0.1% | 3.5% | 57.2% |
| 12 | 0.843 | 51.9% | 31.2% | 0.1% | 9.0% | 7.8% |
| 13 | 0.338 | 13.3% | 36.6% | 0.0% | 20.5% | 29.6% |
| US Avg | 0.721 | 50.4% | 18.3% | 1.1% | 20.0% | 10.2% |

In various embodiments, fuel economy for BEVs may be obtained from a publicly available or proprietary database. In one embodiment, U.S. EPA data for fuel economy of BEVs is used, and is reported in MPGe, miles per gallon equivalent, based on combustion of a gallon of gasoline releasing 121 MJ (33.7 kWh) of energy. The following Equation (2) may be used to calculate the annual metric tons of CO₂ eq emissions for a BEV operating in a particular state or other geographic region:

$${GHGe}_{WTW} = VMT \frac{{f}_{elec , region}}{1000 MPG e} \frac{33.7 kWh}{gal} \qquad ( 2 )$$

where VMT represents annual travel (miles), MPGe is the EPA label mile/gallon equivalent fuel economy, f_{elec,region} is the electricity generation emission factor (kg CO₂ eq/kWh) for a state or region (Table 3, FIG. 2), and assuming 33.7 kWh/gallon of gasoline.

PHEVs operate using a combination of electricity from the grid and internal combustion energy. PHEV CO₂ emissions may be calculated as a weighted average of WTW CO₂ from electric mode and internal combustion mode based on the shares of travel that take place in each mode. The utility factor (λ) is the share of travel in electric mode, often referred to as battery charge-depleting mode. In the U.S., the fuel economy label provides the all-electric range (AER) in miles. Assuming one charge per day, the annual utility factor λ may be estimated as the AER multiplied by 365 and divided by the annual total mileage. Like BEVs, the carbon intensity of electricity used by PHEVs varies by region of operation. Equation 3 provides a representative calculation to determine the annual metric tons of GHGs emitted by a PHEV operating in a particular state or other geographic region.

GHGp_{WTW}=(1+λ)GHGe_{WTW}+λGHG_{WTW}, (3)

where λ is the share of travel in electric (charge-depleting) mode, GHG_{WTW} from (1) is the emissions from gasoline and GHGe_{WTW} from (2) is the emissions from electricity generation.

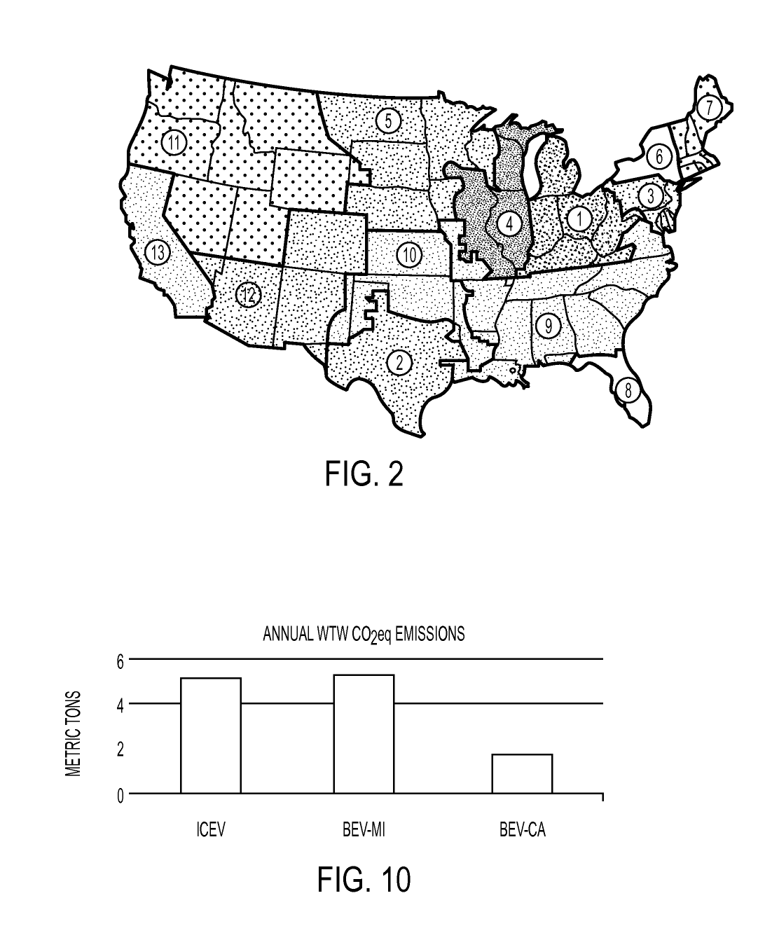

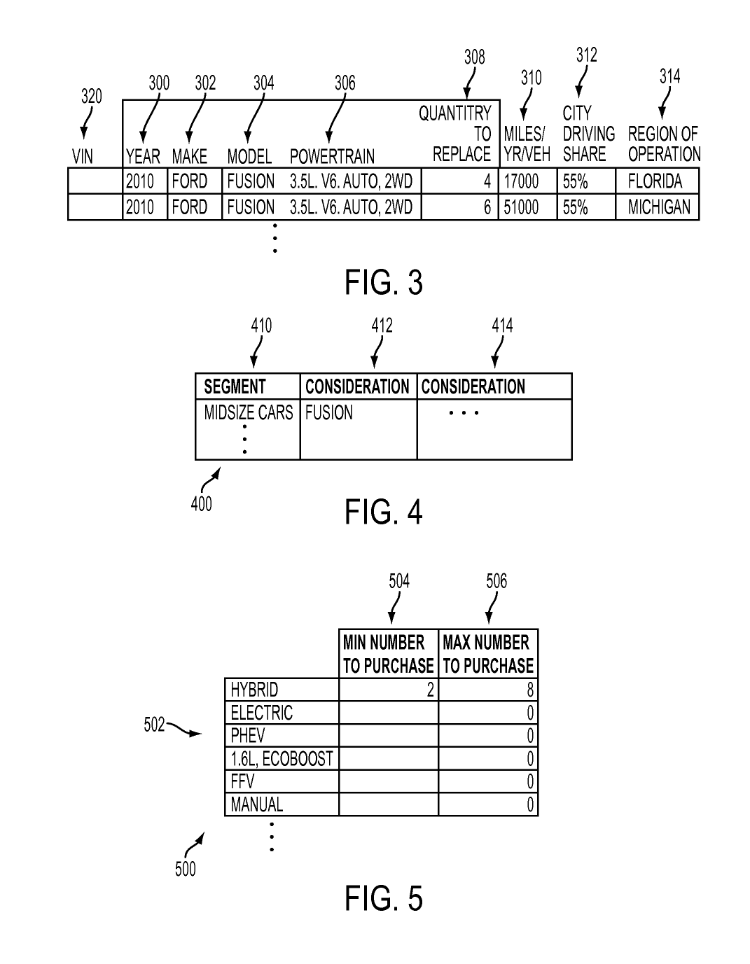

As previously described, one embodiment provides a user interface implemented by a Microsoft Excel® user interface. Of course various other user interface implementations may be used to facilitate transfer of information from fleet customers or other users. In one embodiment, fleet customers may upload information on their current fleets to an input screen or template as generally illustrated in FIG. 3. Data collected may include year 300, make 302, model 304, and powertrain 306, which are mapped to EPA fuel economy data. Alternatively, data may include a VIN 320 that may be used to determine year 300, make 302, model 304, and powertrain 306 using a corresponding VIN database. The number or quantity of vehicles in the existing fleet to replace 308 is also provided. In one embodiment, data entered for quantity to replace 308 are used to generate the flow-balance constraints (6), (11), (12), (17), (22) and (23) for the integer programming models as described in greater detail below. Optional data provided by the user may include annual mileage 310, city driving share 312, and region of operation 314, which may be used to calculate the current state/region CO₂ and to generate vehicle replacement, acquisition, and/or deployment recommendations to achieve a specified objective or goal, such as minimizing emissions or cost. In various embodiments, default values may be used if values are not specified by the user. As those of ordinary skill in the art will recognize, data may be manually entered or electronically transferred from a formatted input file, such as a CSV, tab-delimited, or other standard format, for example.

FIG. 4 illustrates a representative vehicle segmentation or type table used for entering and/or storing cross-reference information for use in selecting suitable replacement vehicles to replace existing fleet vehicles from a designated vehicle market segment or type according to various embodiments of the present disclosure. Vehicle segmentation or type data 410 (midsize, cross-over, SUV, compact, etc.) may be used to determine candidate replacements 412, 414, etc.

(represented by Vᵣ for those vehicles rεR in the integer programming model(s) described in greater detail below). The interface in FIG. 4 may be used to narrow down the subset of candidate replacements Vᵣ from all vehicles of a designated manufacture (Ford in this example) to all configurations of a particular vehicle model (Fusion in this example). For example, a vehicle for replacement, such as a “2010 Ford Fusion 3.5 L, V6, Auto, 2WD”, may be cross-referenced in a segmentation database 400 to determine that this is a midsize car. Another cross-reference database lookup may be used to determine one or more suitable or similar candidate replacement vehicles as represented by data 412, 414. In this example, all Ford Fusion models are determined to be suitable candidate replacement for midsize cars. This interface offers the flexibility to list multiple candidate replacements, so customers can explore various options; for example, the choice for replacement vehicles could move down in size to a compact car or up to a crossover utility vehicle. The available options and ability of the customer or dealer to designate corresponding replacements may vary by application and implementation.

FIG. 5 illustrates a representative user interface data entry template or screen for specifying powertrain types for vehicles to be configured according to various embodiments of the present disclosure. Interface 500 may be used to specify various vehicle options including powertrain types 502 for a minimum number 504 and maximum number 506 of vehicles in the fleet with particular types of powertrains. This same interface can also be used to specify non-powertrain features, such as moonroof, heated seats, safety rating, etc. In the example below, interface 500 is used to limit configurations to a mix of two Fusion vehicles as candidate replacements: an automatic 2.5 L ICEV and a HEV. This may be achieved through feature sets F and constraints (7) and (18) described in greater detail below. For example, a maximum of zero (0) in the “Manual” powertrain specification removes manual transmission Fusion vehicles from consideration. Similarly, a range of 2 to 8 HEVs is designated by minimum number 504 and maximum number 506 in the “Hybrid” data and used for lower limit and upper limit constraints (13) and (24) represented by f^{l} and f^{u}, respectively, on the features and categories for available vehicles in solving the integer programming models described below.

In one embodiment, a mathematical modeling framework known as integer programming is used to automatically generate the vehicle fleet configuration recommendations to achieve at least one customer goal, such as reducing or minimizing emissions, with at least one constraint, such as the total number of vehicles. In other embodiments, more than one customer goal may be provided, such as minimizing cost and minimizing emissions. Integer programs have a linear objective, e.g., to minimize emissions or to minimize the customer's purchase cost for the vehicle purchase recommendation. As one representative example, assume that the objective is to minimize the customer's purchase cost. It is possible to formulate an integer problem for which no solution exists, if the total emissions level e desired by the customer is too low. In that case, the alternate objective of minimizing total emissions combined with removing the emissions constraint allows determination of the lowest level e for which a purchase recommendation is available. This can be the first optimization problem that is executed in the Fleet Purchase Planner 130. In one embodiment, the analytical engine 130 for the Fleet Purchase Planner is implemented in Java® and CPLEX® 12.4 is used to solve the IPs. These IPs are easily solved for fleets with up to several thousand vehicles, with solve times under 1 second on an Intel Core i5® 2.5 GHz CPU with 8 GB RAM running 64 bit Windows 7®.

Those of ordinary skill in the art will recognize that integer programming models are just one possible class of optimization models that can be used for generating fleet configuration recommendations. For example, if the objective or constraints desired are nonlinear, the model can be formulated as a mixed integer nonlinear program.

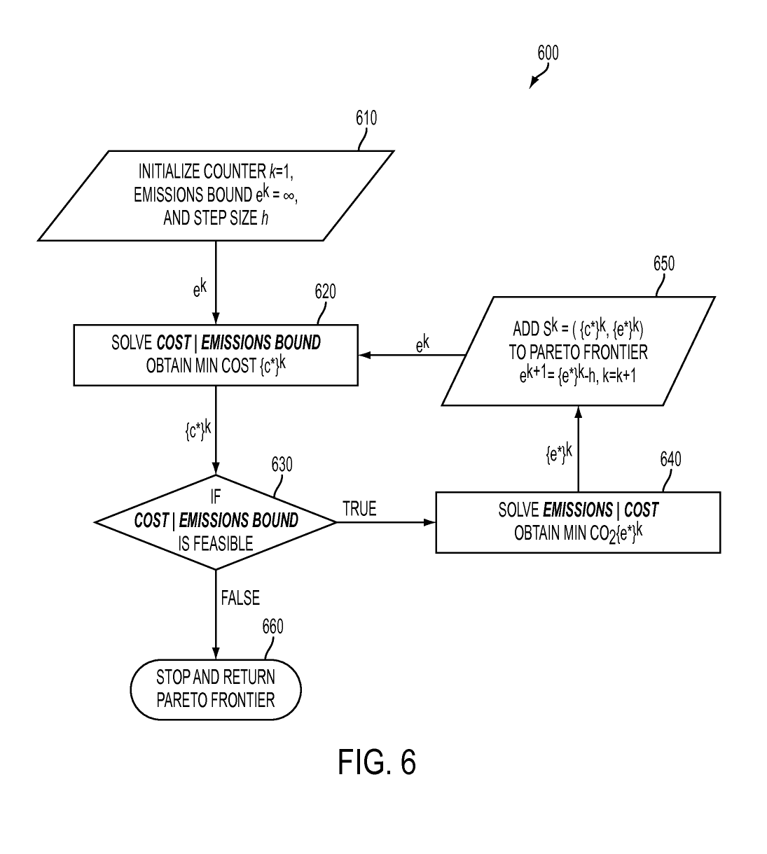

FIG. 6 is a flowchart 600 illustrating operation of one embodiment of a system or method for generating vehicle fleet configuration recommendations according to the present disclosure. In this embodiment, there are two main goals or objectives to achieve in identifying fleet configuration options through optimization: minimizing cost and minimizing emissions. Rather than optimizing to obtain a single purchase recommendation, this embodiment presents recommendations corresponding to points s^{k} from the Pareto frontier from which customers can select a solution based on relative sustainability and cost. Pareto frontier visualization is a classic technique for addressing multi-objective optimization problems.

To generate the vehicle fleet configuration recommendations represented by the Pareto frontier, the algorithm illustrated in FIG. 6 repeatedly solves two optimization problems. After initialization as generally represented by block 610, the first optimization problem generally represented by block 620 minimizes the cost while satisfying a specified emissions bound. The emissions bound may be initialized to a large number or essentially unlimited (∞ in the example illustrated) and then decreased by a designated step size h for each iteration. If the first optimization problem is feasible as generally represented by block 630, the second optimization problem minimizes the emissions by selecting the best replacement strategy given the previously calculated cost as generally represented by block 640. The corresponding point s^{k} and associated emissions value and cost value is stored and process is repeated by decrementing the emissions bound from the emission value of s^{k} by h. The fleet configurations representing the lowest emissions and associated cost, and the lowest cost and associated emissions represent two points on the Pareto frontier as indicated at block 650.

The two optimization problems may be specified by the following:

Cost|Emissions Bound: this IP represented by block 620 minimizes the cost while satisfying the emissions bound e^{k}, which is initialized to ∞ and is then iteratively reduced until the problem becomes infeasible, at which point the algorithm terminates. The objective function value {c*}^{k}, is used as the required cost in the next IP represented by block 640.

Emissions|Cost: this IP represented by block 640 minimizes the emissions {e*}^{k}, by selecting the best replacement strategy given the previously calculated cost {c*}^{k} in block 620. The optimal emissions {e*}^{k} are then reduced by a predetermined step size h to set the emissions bound e^{k+1}={e*}^{k}−h for the next iteration as represented by block 650.

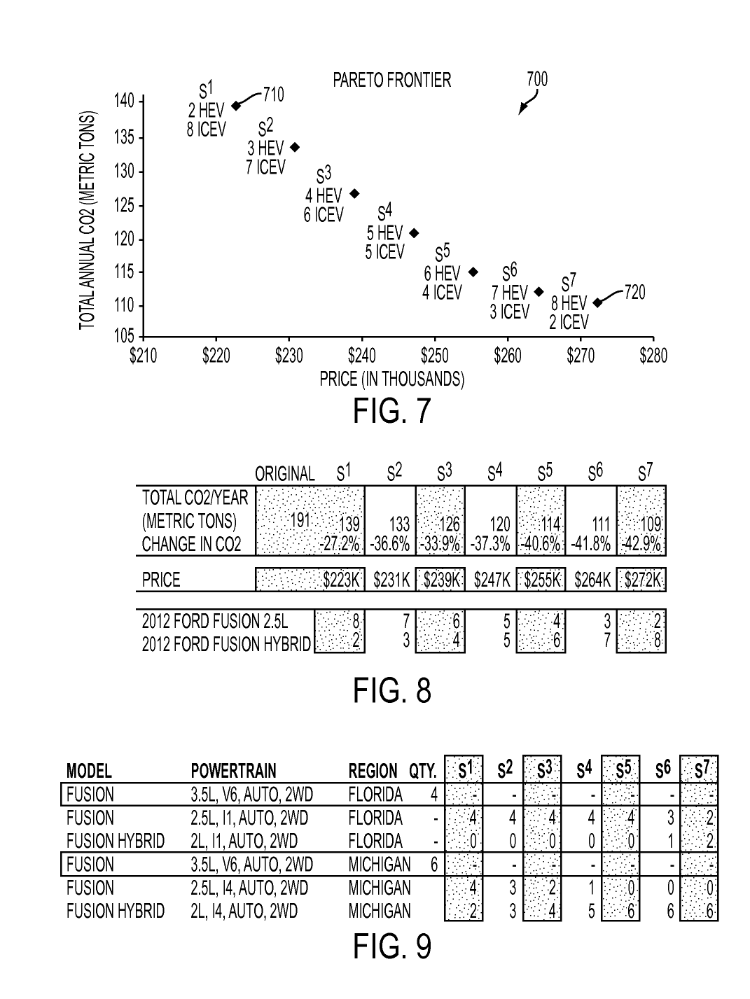

FIG. 7 is a graph illustrating representative fleet configurations to meet one or more customer goals or objectives as determined by a representative embodiment of the present disclosure using the algorithm and representative values generally represented in FIG. 6 and described in greater detail below. The graph of FIG. 7 illustrates what may be referred to as the Pareto frontier 700 of configuration options that include the types and quantities of vehicles to acquire as replacements for currently owned vehicles in a customer's fleet. Pareto frontier 700 includes a first fleet configuration 710 representing the vehicle mix having the lowest cost, while a second fleet configuration 720 representing the vehicle mix having the lowest emissions.

Notation used to illustrate operation of one representative embodiment to formulate the IPs and corresponding example values, denoted by ◯ are as follows:

R is the set of currently owned vehicles being replaced

◯R={2010 Ford Fusion 3.5 L—17K miles/year Florida, 2010 Ford Fusion 3.5 L—51K miles/year Michigan}

qᵣ is the number of units of vehicle rεR being replaced

◯q=[4,6]

V is the set of vehicles available for purchase

◯V={2012 Ford Fusion 2.5 L, 2012 Ford Fusion Hybrid, etc.}

cᵥ is the cost of vehicle vεV (e.g. total cost of ownership or purchase price with or without fuel costs)

◯c=[$20705,$28775, etc.] (starting MSRP price)

Vᵣ⊂V is the subset of vehicles available for purchase that are suitable replacements for currently owned vehicle rεR

◯V1=V2={2012 Ford Fusion 2.5 L, 2012 Ford Fusion Hybrid}

e_{v,r} is the emissions produced by vehicle vεV when replacing vehicle rεR, which is a function of the fuel economy of v and the annual mileage of r

◯e_{1,1}=6.9, e_{2,1}=4.8, e_{1,2}=20.7, e_{2,2}=14.3 (metric tons CO₂)

e^{k} is the maximum emissions allowed at iteration k

◯e^{k}=∞ (no limit initially, to minimize price)

F is the set of vehicle features and categories being considered, for example, moon roof, hybrid, leather, manual, Fusion 2.5 L, Focus, etc.

◯F={hybrid}

f^{l} is a lower-bound on the number of vehicles to be purchased with feature fεF

◯hybrid^{l}=2

f^{u} is an upper-bound on the number of vehicles to be purchased with feature fεF

hybrid^{u}=8

fᵥ is a boolean parameter that indicates whether or not vehicle vεV contains feature fεF

◯hybrid=[false, true].

The decision variables in both integer programs are the same: x_{v,r} is the number of units of vehicle vεV to purchase to replace vehicle rεR.

The Cost|Emissions Bound may be formulated as follows:

{c*}^{k}=minΣ_{rεR}Σ_{vεV}_{ᵣ}cᵥx_{v,r} (4)

s.t. Σ_{rεR}Σ_{vεV}_{ᵣ}e_{v,r}x_{v,r}≦e^{k} (5)

Σ_{vεV}_{ᵣ}xᵥ=qᵣ ∀rεR (6)

f^{l}≦Σ_{rεR}Σ_{f}_{ᵥ}₌ₜᵣᵤₑx_{v,r}≦f^{u} ∀fεF (7)

\vec{x}ε{0,1, . . . } (8)

where (4) minimizes the total purchase cost, (5) sets the emissions limit, (6) is a flow-balance constraint that ensures exactly one vehicle is purchased for each vehicle being replaced, (7) provides lower and upper bounds on features or vehicle types, and (8) requires non-negative integer solutions for the number of vehicles purchased.

Continuing with this example, the minimal purchase cost with no emissions bound (e¹=∞) provides:

{c*}¹=min20705(x_{1,1}+x_{1,2})+28775(x_{2,1}+x_{2,2}) (9)

s.t. 6.9x_{1,1}+4.8x_{2,1}+20.7x_{1,2}+14.3x_{2,2}≦∞ (10)

x_{1,1}+x_{2,1}=4 (11)

x_{1,2}+x_{2,2}=6 (12)

2≦x_{2,1}+x_{2,2}≦8 (13)

\vec{x}ε{0,1, . . . } (14)

where (9) minimizes purchase price, constraint (10) that sets the initial emissions bound e¹=∞ is automatically satisfied, constraint (11) replaces the 4 vehicles in Florida, constraint (12) replaces the 6 vehicles in Michigan, constraint (13) includes between 2 and 8 hybrids, and constraint (14) ensures an integer solution. An optimal solution (but not unique) is x_{1,1}=2, x_{2,1}=2, x_{1,2}=6, x_{2,2}=0, which achieves the lower limit on hybrids of 2 and thereby minimizes purchase cost. The optimal objective value is {c*}¹=$223,190. The emissions level achieved in the left-hand side of (10) is 147.6 metric tons of CO₂. However, this emissions level is not the lowest one achievable for a purchase of 2 hybrids and 8 conventional engine vehicles. As such, another integer program that optimizes emissions for a given cost is used.

The Emissions|Cost may be formulated as follows:

{e*}^{k}=minΣ_{rεR}Σ_{vεV}_{ᵣ}e_{v,r}x_{v,r} (15)

s.t. Σ_{rεR}Σ_{vΣV}_{ᵣ}cᵥx_{v,r}={c*}^{k} (16)

Σ_{cεV}_{ᵣ}xᵥ=qᵣ ∀rεR (17)

f¹≦Σ_{rεR}Σ_{f}_{ᵥ}₌ₜᵣᵤₑx_{v,r}≦f^{u} ∀fεF (18)

\vec{x}ε{0,1, . . . } (19)

where (15) minimizes emissions, (16) ensures the purchase cost is the same as the optimal solution {c*}^{k} of the Cost|Emissions Bound in (4), and constraints (17)-(19) are the same as constraints (6)-(8). The resulting solution data point s^{k}=({c*}^{k},{e*}^{k}) is added to the Pareto frontier, and the value for e^{k+1} is reduced to {e*}^{k}−h, where h is a predetermined step size.

Continuing this example provides:

{e*}¹=min6.9x_{1,1}+4.8x_{2,1}+20.7x_{1,2}+14.3x_{2,2} (20)

s.t. 20705(x_{1,1}+x_{1,2})+28775(x_{2,1}+x_{2,2})=223190 (21)

x_{1,1}+x_{2,1}=4 (22)

x_{1,2}+x_{2,2}=6 (23)

2≦x_{2,1}+x_{2,2}≦8 (24)

\vec{x}ε{0,1, . . . } (25)

The optimal solution (unique) is x_{1,1}=4, x_{2,1}=0, x_{1,2}=4, x_{2,2}=2. While the same vehicles are purchased as in Cost|Emissions Bound, the optimal emissions level achieved of {e*}¹=139 metric tons of CO₂ is 6% lower; this emissions reduction emphasizes the importance of deploying or placing the vehicles optimally as also illustrated in FIG. 10. s¹=({c*}¹,{e*}¹)=($223,190; 139 metric tons CO₂) is added to the Pareto frontier, and the value for e² is reduced to 138 metric tons CO₂, where the step size is h=1 metric ton CO₂.

The algorithm continues to compute the second point in the Pareto frontier by substituting e²=138 metric tons CO₂ into the right-hand side of constraint (10) and resolving Cost|Emissions Bound as represented at 620. An optimal solution (again not unique) is x_{1,1}=1, x_{2,1}=3, x_{1,2}=6, x_{2,2}=0, which includes 3 hybrids. This is the minimum number of hybrids that can be purchased while satisfying the emissions bound of 138 metric tons CO₂. The optimal objective cost value is {c*}²=$231,260. The emissions level achieved in the left-hand side of (10) is 145.5 metric tons of CO₂. Similarly to the first iteration (k=1), this emissions level is not the lowest one achievable for a purchase of 3 hybrids and 7 conventional engine vehicles.

To find the emissions level for the second point in the Pareto frontier, the value for {c*}²=$231,260 is substituted into the right-hand side of constraint (21) to resolve the Emissions|Cost IP as represented by 640. The optimal solution (unique) is x_{1,1}=4, x_{2,1}=0, x_{1,2}=3, x_{2,2}=3. While the same vehicles are purchased as in the Cost|Emissions Bound, the optimal emissions level achieved of {e*}²=132.6 metric tons of CO₂ is 9% lower. The resulting s²=({c*}²,{e*}²)=($231,260; 132.6 metric tons CO₂) is added to the Pareto frontier, and the value for e³ is reduced to 131.6 metric tons CO₂.

The algorithm, summarized in FIG. 6, continues to iteratively solve the Cost|Emissions Bound IP 620 and Emissions|Cost IP 640 for k=3, 4, 5, 6, 7 to provide additional solution points s³, s⁴, s⁵, s⁶, s⁷ at 650. At k=8, no further emissions reductions are achievable due to the limit of 8 hybrids, which yields an infeasible Cost|Emissions Bound IP at 630, and the algorithm terminates as represented by block 660.

The Pareto frontier for the example in FIG. 6 shows solutions for all iterations k=1, . . . , 7 as shown in the graph of FIG. 7, summary report of FIG. 8, and detailed report of FIG. 9. These solutions describe which combinations of vehicles to purchase to replace the 10 vehicles: the solution varies between 2 and 8 HEVs and ICEVs. While the points in FIG. 7 are spaced evenly with respect to price, the CO₂ reductions become smaller when 7 and 8 HEVs are chosen for purchase; this can be explained by the higher mileage on the 6 Michigan vehicles, where hybrids are first optimally placed, compared with the lower mileage of the Florida vehicles, where HEVs 7 and 8 are placed. This simplified example is sufficiently concise to solve with logic and intuition alone due to the constraints placed on the number of vehicles and limited vehicle powertrain configurations. However, with large fleets containing vehicles with variable mileage and more vehicles considered as candidate replacements, the Pareto frontier is quite useful in identifying strategic fleet configurations that may be acceptable to a particular customer. While the representative embodiment used to illustrate operation of a vehicle fleet configuration tool according to the present disclosure used purchase price and emissions as customer parameters or objectives, the system and method may be used with other objectives such as minimizing purchase price plus fuel costs for a given number of years and minimizing total cost of ownership, for example.

In addition to the Pareto frontier shown in FIG. 7, there is other information that could be useful to the customer. The representative summary report shown in FIG. 8 highlights the improvement in sustainability corresponding to each point on the Pareto frontier compared with the current or original configuration of the fleet. This report may also include comparisons of fuel expenditure over a given time period relative to purchase price, further illustrating the relationship between cost and sustainability. The representative detailed report in FIG. 9 provides the optimal placement or geographic deployment of each vehicle acquired for the various scenarios. It can also include summary statistics for annual fuel expenditure and CO₂ emissions on the individual vehicle level, compared to the current level for the vehicle being replaced. Each new vehicle being purchased appears below the vehicle it is replacing. Notice that in the minimum cost configuration scenario s¹, the two HEVs purchased replace the higher mileage vehicles in Michigan. As the upper bound on emissions e^{k} is lowered at each iteration k, more vehicles in Michigan are replaced with HEVs. Only after all the Michigan vehicles have been replaced with hybrids, at s⁵, is a vehicle in Florida replaced with a hybrid.

FIG. 10 illustrates the impact of vehicle deployment recommendations for geographic regions. FIG. 10 compares the CO₂ eq emissions of a 2012 Ford Focus, ICEV relative to a BEV. As illustrated, the WTW emissions for the ICEV are about the same as a BEV driven in Michigan with coal-intense electricity, but are nearly 3 times higher than a BEV driven in California with large shares of nuclear and renewable electricity.

As such, various embodiments according to the present disclosure provide an integrated and comprehensive system and method for quickly, efficiently, and automatically generating fleet purchase recommendations to satisfy customer goals and requirements, such as those associated with a fleet emissions footprint or cost of ownership, for example. Various embodiments provide an interactive tool that can be used by fleet account managers and/or customers to automatically develop tailored purchase recommendations for fleet customers. The recommendations help customers achieve one or more fleet goals, such as sustainability and financial targets, while taking into account safety ratings and other vehicle preferences, when planning fleet purchases and/or analyzing current fleet configurations.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention. While the best mode has been described in detail, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, ease-of-use, life cycle cost, marketability, appearance, packaging, size, serviceability, etc. Any embodiments that are described as less desirable than other embodiments or prior art implementations with respect to one or more characteristics are not outside the scope of the disclosure and may be desirable for particular applications.

What is claimed is:

1. A system for generating a vehicle fleet configuration, comprising:
an input device configured to receive user input indicative of a number of vehicles to configure and at least one fleet operational parameter target;
a computer in communication with the input device and a database having fuel economy and emissions information for a plurality of available vehicle models and powertrain configurations, the computer configured to generate a recommended number of vehicles for one or more of the available vehicle models with associated powertrain configurations to satisfy the number of vehicles to purchase, wherein the operational parameters associated with the number of vehicles satisfy the fleet operational parameter target.

2. The system of claim 1 wherein the system includes an optimization component to select the number of vehicles for each model and powertrain configuration to minimize vehicle fleet emissions.

3. The system of claim 1 wherein the system includes an optimization component to select the number of vehicles for each model and powertrain configuration to minimize vehicle fleet acquisition cost.

4. The system of claim 1 wherein the computer is configured to generate a recommended region for deployment for the recommended vehicles to satisfy the fleet operational parameter target.

5. The system of claim 4 wherein the fleet operational parameter target includes cost and emissions.

6. The system of claim 1 wherein the input device is configured to receive information indicative of vehicles in an existing vehicle fleet to be replaced, and wherein the computer includes an optimization component to select replacement vehicles from a similar vehicle segmentation category for acquisition to meet the fleet operational parameter target.

7. The system of claim 6 wherein the information indicative of vehicles in the existing vehicle fleet comprise at least one vehicle identification number (VIN) and wherein the computer is configured to access at least one database to determine a vehicle powertrain configuration, mileage, and emissions based on the VIN.

8. The system of claim 1 wherein the input device communicates with the computer over a network.

9. The system of claim 1 wherein the computer comprises an optimization component configured to solve a first linear programming model to generate a fleet configuration that minimizes fleet emissions and a second linear programming model to generate a fleet configuration that minimizes a fleet cost parameter.

10. The system of claim 9 wherein the fleet cost parameter comprises acquisition cost.

11. The system of claim 9 wherein the fleet cost parameter comprises cost of operation over a predetermined time period.

12. The system of claim 9 wherein the computer is configured to generate multiple fleet configurations each having an associated fleet emissions and fleet acquisition cost, wherein a first fleet configuration represents a minimum fleet emissions configuration and a second fleet configuration represents a minimum fleet cost configuration.

13. The system of claim 1 wherein the computer is configured to generate multiple fleet configurations each representing a minimum cost fleet for a computed emissions level.

14. The system of claim 13 wherein cost represents purchase cost or total cost of ownership.

15. A computer-implemented method for generating vehicle fleet configurations, comprising:
receiving input from an input device that includes a number of vehicles and at least one fleet operational target;
accessing a database using a computer to determine emissions and cost data for a plurality of available vehicles having different powertrain configurations; and
outputting at least one fleet configuration using the computer that includes powertrain configurations for available vehicles to meet the target and number of vehicles.

16. The method of claim 15 wherein the fleet operational target comprises minimizing emissions, the method further comprising selecting available vehicles having powertrain configurations to minimize fleet emissions for the at least one fleet configuration.

17. The method of claim 16 further comprising outputting multiple fleet configurations each having an associated cost and emissions and each representing a minimum cost fleet for a computed emissions level.

18. The method of claim 17 wherein cost represents acquisition cost or total cost of ownership.

19. The method of claim 15 wherein receiving input comprises receiving vehicle information including at least one vehicle identification number (VIN) of fleet vehicles to be replaced.

20. The method of claim 19 further comprising accessing a database to determine vehicle model, segmentation, and powertrain configuration based on the VIN.

21. A method for generating a vehicle fleet configuration, comprising:
receiving input from a microprocessor-based input device that includes at least one vehicle identification number (VIN) of a vehicle to be replaced and a desired number of vehicles to acquire;
accessing a database over a computer network to retrieve available vehicles having associated powertrain configurations and associated emissions and cost information; and
using a computer to calculate emissions and cost information associated with each of a plurality of fleet configurations and geographic deployments that meet the desired number of vehicles to acquire and replace including a first fleet configuration and deployment having minimized emissions and a second fleet configuration and deployment having minimized cost.

22. The method of claim 21 wherein the computer solves a first integer programming model that minimizes emissions and a second integer programming model that minimizes cost.

23. The method of claim 22 wherein the computer accesses a database based on the VIN to determine associated emissions information for the vehicle to be replaced.
